(19) United States
(12) Patent Application Publication
(10) Pub. No.: US 2025/0262788 A1
(43) Pub. Date: Aug. 21, 2025

(54) CLAMPING DEVICE AND ASSEMBLY FOR CLAMPING A DIE BOARD ONTO A DIE HOLDING CYLINDER OF A ROTARY DIE CUTTER

(71) Applicant: MACARBOX S.L.U, Irura (ES)

(72) Inventor: Antonio IZAGUIRRE, Irura (ES)

(21) Appl. No.: 18/858,480

(22) PCT Filed: Apr. 19, 2023
(86) PCT No.: PCT/EP2023/060105

§ 371 Date: Oct. 21, 2024

(30) Foreign Application Priority Data
Apr. 22, 2022 (EP) 22382381.6

(51) Int. Cl. B26D 7/26; B26F 1/38

(52) U.S. Cl. CPC B26D 7/2614; B26F 1/384; B26D 2007/2607

(57) ABSTRACT

A clamping device for clamping a die board onto a die holding cylinder of a rotary die cutting machine includes a fluid pressure cylinder with an axially displaceable piston. A clamping bolt is attached to the piston, the clamping bolt has a shank and a head extending radially from the shank. The fluid pressure cylinder is configured for displacing the piston axially outwards in response to injection of fluid into the fluid pressure cylinder. The clamping device further includes a clamping spring arranged to bias the piston axially inwards.

The clamping bolt has a threaded portion by which the clamping bolt is attached to the piston by a threaded connection. The head of the clamping bolt may be configured to facilitate the application of torque to the clamping bolt for releasing the clamping bolt from the piston by unscrewing.

### CROSS-REFERENCE TO RELATED APPLICATIONS

This application is a 35 U.S.C. § 371 National Stage patent application of PCT/EP2023/060105, filed on 19 Apr. 2023, which claims the benefit of European patent application 22382381.6, filed on 22 Apr. 2022, the disclosures of which are incorporated herein by reference in their entirety.

### TECHNICAL FIELD

The present disclosure is related to the technical field of rotary die cutters.

### BACKGROUND

Rotary die cutters known in the art typically comprise a rotationally arranged cylinder on which elements (typically, wooden elements) known as dies or die boards, provided with blades, are mounted. In use, the die holding cylinder is typically rotated to bring the blades in contact with a cardboard blank fed between the die holding cylinder and another cylinder, so as to cut and shape the cardboard in a predetermined manner, for example, according to the type of box to be produced.

It is known in the art to attach the die boards to the die holding cylinder by means of screws. Whereas this provides for a stable and reliable attachment between the die boards and the cylinder, it also involves an important disadvantage: replacement of the dies typically involves a substantial amount of work and takes a considerable time. Thus, there is a need for alternative means for attaching the die boards to the die holding cylinder, preferably allowing for easy and quick attachment and detachment, so as to facilitate the replacement of the dies. Also, the attachment must be reliable and stable, and the attachment means should be compatible with a substantial durability of all components involved, including the die boards which, as indicated above, may be of wood or of other relatively sensitive materials.

U.S. Pat. No. 5,638,733-A discloses what appears to be a complex mechanical system for attaching the die boards to the die holding cylinder. The system includes a plurality of longitudinal bars attached to the dies and extending in the axial direction of the machine, the bars featuring C-shaped sections. The die holding cylinder is provided with openings to receive the bars, and with spring-loaded displaceable locking teeth that are operated by means of longitudinal control rods slidably arranged in longitudinal recesses in the die holding cylinder. Operation of the system involves a combination of movement of the rods in the axial direction and movement of the locking teeth in the circumferential direction.

U.S. Pat. No. 5,003,854-A likewise discloses a mechanical die board attachment system involving axial displacement of locking members, namely, of longitudinally extending locking rods having an inverted T shaped cross section and arranged in longitudinally extending grooves machined in the die holding cylinder. The locking rods are displaceable in the axial direction by means of spindles arranged in correspondence with an axial end of the die holding cylinder, between a locking position and an unlocking position. In the locking position the locking rods enter into lateral recesses in arc-shaped ribs attached to the inner surface of the die boards and extending in the circumferential direction. That is, also this is a purely mechanical system in which axially extending rods are displaced by acting on the rods at an axial end of the die holding cylinder. In the case of U.S. Pat. No. 5,003,854-A, the rods are displaced by rotation of the spindles. One potential drawback of the system is related to the need to carefully position the die boards on the die holding cylinder so as to correctly insert the arc-shaped ribs in corresponding circumferentially extending grooves in the surface of the die holding cylinder.

U.S. Pat. No. 6,925,923-B2 discloses a fluid-actuated, typically a pneumatically actuated, attachment system including a double-acting pneumatic cylinder in which a piston is slidably arranged so that it can slide in the axial direction of the pneumatic cylinder (corresponding to the radial direction of the die holding cylinder). The piston is selectively driven axially outwards (upwards in the figures) or axially inwards (downwards in the figures) (that is, radially outwards or radially inwards if the die holding cylinder is taken as the reference), depending on whether fluid is driven into a lower chamber and out of an upper chamber of the pneumatic cylinder, or vice-versa. The piston is attached to a clamping bolt having an elongate shank or stem extending in the axial direction of the pneumatic cylinder, that is, in the radial direction if the die holding cylinder is taken as the reference. The clamping bolt comprises a free end with a head that extends radially outwards in relation to the shank. On the other hand, the system includes a die board provided with a recess in one of its surfaces, the recess being provided with an opening comprising a wider portion shaped and dimensioned to allow for the head of the clamping bolt to pass through the wider portion of the opening, and a narrower portion shaped and dimensioned so as not to allow the head of the clamping bolt to pass through the narrower portion of the opening, so as to apply a clamping force onto the die board in the recess. Thus, after placing the die board onto the die holding cylinder, the pneumatic cylinder can be activated to first push the clamping bolt outwards, through the wider portion of the opening in the die board. Thereafter, the die board is shifted in the circumferential direction of the die holding cylinder so that the head of the clamping bolt is positioned in correspondence with the narrower portion of the opening, whereafter the pneumatic cylinder is activated in the opposite direction, displacing the piston and the clamping bolt axially inwards (radially inwards if the die holding cylinder is taken as the reference) so as to apply a clamping force onto the die board. The surface around the narrower portion of the opening is recessed from the general top surface of the die board and inclined in a way that matches the shape of the bottom portion of the head of the clamping bolt.

An alternative arrangement, likewise based on pneumatic cylinders driving clamping bolts with heads interacting with recesses in the die boards is known from U.S. Pat. No. 7,171,885-B1. Here, the pneumatic cylinder is a single-acting pneumatic cylinder that drives the respective clamping bolt outwards while compressing a clamping spring, which applies an inwardly directed clamping force on the clamping bolt.

A problem involved with the systems known from U.S. Pat. No. 6,925,923-B2 and U.S. Pat. No. 7,171,885-B1 is that the preparation of the openings in the die boards is a complex process, due to the complex shapes of the openings. An additional problem is that the application of the clamping forces directly onto the die board in correspondence with the recessed areas surrounding the narrower portions of the openings implies a risk of damage to the die boards, and/or a need to limit the magnitude of the clamping forces. Substantial clamping forces can often be preferred in order to ensure reliable clamping of the die boards so as to keep them stable during operation. An additional problem is that in the case of a failure in the operation of the pneumatic cylinder in the clamped state of the die board, the mechanism may remain jammed and removal of the clamping bolt may be difficult. A yet further problem with the system known from U.S. Pat. No. 6,925,923-B2 is that there may be a drop in the pneumatic clamping forces (for example, due to an interruption in the supply of electrical energy), so that the die holding cylinder continues to rotate without the die boards being correctly clamped to it. This may imply a risk that one or more die boards become released due to the centrifugal forces acting on them.

ES-2691168-A1 discloses a system somewhat similar to the one known from U.S. Pat. No. 7,171,885-B1, but here the clamping bolt features a head having an elongate shape that matches the shape of an elongate opening in the die board. After passing axially outwards through the opening, the clamping bolt is turned 90 degrees about its axis so that it can apply a clamping force onto the die board. Also here a problem is that the clamping bolt applies the clamping force directly onto the surface of the die board. Also, the combination of axial and rotary movements implies a relatively complex mechanism, with a substantial amount of moving parts. This increases complexity, cost and risk of failure.

### SUMMARY

A first aspect of the disclosure relates to a clamping device for clamping a die board onto a die holding cylinder of a rotary die cutting machine, that is, of a rotary die cutter. The clamping device comprises a fluid pressure cylinder (such as a pneumatic or hydraulic cylinder) with an axially displaceable piston. A clamping bolt. is attached to the piston. The clamping bolt comprising a shank and a head extending radially from the shank. The head can extend from the shank in any way that makes it appropriate for applying a clamping force on a die board or on, for example, an interface member as described below.

The fluid pressure cylinder is configured for displacing the piston axially outwards in response to injection of fluid into the fluid pressure cylinder. The expression “axially outwards” refers to the axis of the fluid pressure cylinder and is intended to imply that the piston will be driven radially away from the center of a die holding cylinder when the fluid pressure cylinder is incorporated into the die holding cylinder as intended.

The clamping device further comprises a clamping spring arranged to bias the piston axially inwards. Thus, when the piston is displaced axially outwards it compresses the clamping spring, which thus biases the piston axially inwards, or, if the axis of the die holding cylinder is taken as a reference, radially inwards. It is the clamping spring that provides the clamping force applied to the die board and/or to the interface member via the clamping bolt.

In accordance with this first aspect of the disclosure, the clamping bolt comprises a threaded portion by which the clamping bolt is attached to the piston by a threaded connection. The use of a threaded connection facilitates removal of the clamping bolt from the rest of assembly by unscrewing, which can be useful in, for example, the case of a failure in the operation of the assembly such as, for example, jamming of the piston or other failure in the operation of the fluid pressure cylinder. Also, in accordance with this first aspect of the disclosure, the head of the clamping bolt is preferably configured to facilitate the application of torque to the clamping bolt for releasing the clamping bolt from the piston by unscrewing, that is, by rotating the clamping bolt until it is disengaged from its attachment to the piston. That is, differently from the bolts known from for example U.S. Pat. No. 7,171,885-B1, the head is actually preferably configured for facilitating the unscrewing of the bolt. The expression “configured to facilitate the application of torque” is to be interpreted broadly, basically, as encompassing any configuration suitable to facilitate the application of torque, typically, due to an external shape and/or a recess in the head that facilitates the application of torque by interaction between a tool (for example, a screwdriver, a wrench, etc.) and the head, compared to the kind of simple circular flat head known from, for example, U.S. Pat. No. 6,925,923-B2 and U.S. Pat. No. 7,171,885-B1.

In some embodiments of the disclosure, a nut is provided in the piston, the threaded portion of the clamping bolt being engaged with an internal thread of the nut. In some embodiments, the nut is arranged within the piston in an axially displaceable manner, the nut being biased axially outwards by a nut supporting spring. The term “nut supporting spring” is used to distinguish this spring from the clamping spring. The purpose of this spring is to allow the clamping bolt to be displaced axially inwards in relation to the piston if the piston is displaced axially outwards while the clamping bolt is not being positioned in correspondence with the wider portion of an opening in, for example, an interface member as described below but, for example, under a die board away from a through hole. In many potential uses of the disclosure, a die holding cylinder is provided with multiple devices as described above, which are all activated simultaneously, whereas only some of them are placed with their clamping bolts placed facing a larger portion of an opening in an interface member as described below. The clamping bolts of the rest of the devices will face resistance from above when the fluid pressure cylinders are activated, and this resistance will cause the nut supporting springs to be compressed, rather than the clamping bolts being forced upwards, potentially causing damage to the die board or to an interface member being placed in the die board, or causing displacement of the die board or interface member.

In some embodiments of the disclosure, the nut is blocked against rotation. The nut preferably has an external shape (for example, a polygonal shape in cross section) matching an internal shape (for example, a polygonal shape in cross section) of a portion of the piston, so that the nut can slide in the axial direction within the piston, but is blocked against rotation. Blocking the nut against rotation may facilitate or ensure easy unscrewing of the clamping bolt in the case of, for example, jamming of the device.

In some embodiments of the disclosure, the piston is blocked against rotation in relation to the fluid pressure cylinder. This can serve to help to ensure easy unscrewing of the clamping bolt in the case of a failure of the mechanism.

In some embodiments of the disclosure, the head of the clamping bolt comprises a portion with a circumference having a non-circular cross section, preferably a polygonal cross section. The use of a circumference having a non-circular cross section, such as a polygonal cross section, for example, a hexagonal cross section, can favor easy unscrewing of the clamping bolt in the case of jamming of the mechanism, using an appropriate tool.

In some embodiments of the disclosure, the head of the clamping bolt comprises a recessed portion adapted for insertion of a tool for unscrewing the clamping bolt. For example, the recess can be a simple linear recess or a star-shaped recess arranged to receive a correspondingly shaped tip portion of a screwdriver, or it can be a polygonal recess such as a hexagonal recess configured to interact with a hex key such as an Allen wrench, etc.

A second aspect of the disclosure relates to an assembly comprising a clamping device as described above, the assembly further comprises an interface member configured to be coupled to a die board, the interface member comprising an opening having a wider portion shaped and dimensioned to allow the head of the clamping bolt to pass through the wider portion, and a narrower portion shaped and dimensioned so as not to allow the head of the clamping bolt to pass through the narrower portion, so as to allow the clamping bolt to apply a clamping force onto the interface member. By clamping the interface member to the die holding cylinder, the die board to which the interface member is coupled will likewise become clamped to the die holding cylinder.

Whereas the use of an interface member at a first look may seem sub-optimal in that it represents the use of an additional component which might increase complexity and costs, the inventors have found that such potential drawbacks can be more than compensated by several potential advantages. First of all, it makes it possible to use through holes in the die board that are of much simpler design than those known from for example U.S. Pat. No. 6,925,923-B2 and U.S. Pat. No. 7,171,885-B1 or to even avoid the need for such through holes. In particular, there will no longer be any need for through holes with a shape that is conditioned by the need to, on the one hand, allow for the passage of the head of the clamping bolt and, on the other hand, provide for selective retention of the head of the clamping bolt. Also, the clamping force will no longer be applied by direct contact between the head of the clamping bolt and the surface of the die board, for example, the upper surface in a recess in the die board. Instead, the clamping force will be applied to the interface member. Depending on the characteristics of the interface member, the clamping force may be distributed over a contact surface between the interface member and the die board that is determined by parameters such as, for example, the shape and dimensions of the interface member, or by the way in which the interface member is coupled to the die board. Substantial clamping forces, such as clamping forces of more than 2000 N, such as more than 2500 N, can be applied to an interface member without any substantial risk of damage to the die board. High clamping forces can be preferred to avoid displacement during high speed rotation of the die holding cylinder during operation. The interface members can be mass manufactured in appropriate installations and recycled for use in successive die boards. Thus, multiple advantages are obtained by using the interface members as an interface between the clamping bolt and the die board. That is, and whereas the mindset of the person skilled in the art generally seems to be that it is important to minimize the number of components used, it has been found that in the specific context of rotary die cutters, the advantages obtained by the use of interface members outweigh the drawbacks represented by the potentially enhanced complexity represented by the use of an additional component.

In some embodiments, the interface member is of metal. Metal interface members can be manufactured using conventional metal processing means, at very reasonable costs. At the same time they can provide good performance in terms of resistance to wear and deformation, for example, also under high clamping forces exerted by the clamping bolt against the surface of the interface member adjacent to the narrower portion of the opening. Also, metal interface members can be manufactured with very precise shapes and small tolerances.

In some embodiments, the interface member is an insert to be inserted into a through hole in a die board, the insert comprising a bottom with the opening. In some embodiments, the insert comprises a laterally extending rim portion surrounding at least part of the upper end of the insert, the rim portion being configured for being supported on an upper surface of a die board when the insert is placed in a through hole in the die board. The insert may have a tapered shape so that the area of the upper end of the insert is smaller than the area of the lower end of the insert, also when disregarding the rim portion.

In some embodiments, the interface member is configured to be attached to an inner surface of a die board, for example, by means of screws; the term “inner surface” refers to the surface of the die board that faces the die holding cylinder when the die board is attached thereto. The clamping device and/or the die holding cylinder optionally comprises a recess for receiving at least part of the interface member. Optionally, the interface member is arc-shaped.

One advantage with the use of interface members adapted to be attached to an inner surface of the respective die board is that there is no need to ensure the presence of specifically adapted openings or through holes in the die board. The presence of one or more recesses in the clamping device and/or in the die holding cylinder, for receiving the respective interface member, allows the die board to abut against the surface of the die holding cylinder and/or the clamping device, in spite of the presence of the interface member on the radially inner surface of the die board. For example, arc-shaped interface members that extend in the circumferential direction of the die holding cylinder may be received in circumferentially extending recesses or grooves in the external surface of the die holding cylinder and in the radially outer portion of the clamping device, such as in a cover of the clamping device.

This kind of interface member and clamping device can serve to provide for a reliable clamping whereby the interface member can also help to correctly position to die boards in relation to the die holding cylinder, for example, in a correct position in relation to the axis of the die holding cylinder. This kind of interface members can be compatible with die boards without through holes or without through holes featuring a special shape. The positioning of the interface member at least partly in a recess in the clamping device and/or in the die holding cylinder can help to ensure alignment between the clamping device and the opening in the interface member. When the interface member can slide in a recess in the circumferential direction of the die holding cylinder, this can serve to shift the die board between a position in which the clamping bolt is arranged in correspondence with the wider portion of the opening in the interface member, and a position in which the clamping bolt is arranged with its shank in the narrower portion of the opening.

A further aspect of the disclosure relates to an assembly for clamping a die board onto a die holding cylinder of a rotary die cutting machine, that is, of a rotary die cutter. The assembly comprises a clamping device comprising a fluid pressure cylinder (such as a pneumatic or hydraulic cylinder) with an axially displaceable piston. A clamping bolt is attached to the piston. The clamping bolt comprising a shank and a head extending radially from the shank. The head can extend from the shank in any way that makes it appropriate for applying a clamping force on a die board or on, for example, an interface member as described below.

The fluid pressure cylinder is configured for displacing the piston axially outwards in response to injection of fluid into the fluid pressure cylinder. The expression “axially outwards” refers to the axis of the fluid pressure cylinder and is intended to imply that the piston will be driven radially away from the center of a die holding cylinder when the fluid pressure cylinder is incorporated into the die holding cylinder as intended.

The device further comprises a clamping spring arranged to bias the piston axially inwards. Thus, when the piston is displaced axially outwards it compresses the clamping spring, which thus biases the piston axially inwards, or, if the axis of the die holding cylinder is taken as a reference, radially inwards. It is the clamping spring that provides the clamping force applied to the die board and/or to the interface member via the clamping bolt.

In accordance with this aspect of the disclosure, the assembly further comprises an interface member configured to be coupled to a die board, the interface member comprising an opening having a wider portion shaped and dimensioned to allow the head of the clamping bolt to pass through the wider portion, and a narrower portion shaped and dimensioned so as not to allow the head of the clamping bolt to pass through the narrower portion, so as to allow the clamping bolt to apply a clamping force onto the interface member. What has been explained about the interface member and possible embodiments thereof in relation to the above described second aspect of the disclosure also applies to this aspect of the disclosure.

Yet another aspect of the disclosure relates to a die cutting machine comprising a die holding-cylinder and a plurality of clamping devices or assemblies as described above, wherein the clamping devices are inserted in recesses in the die holding cylinder.

In some embodiments, the die cutting machine further comprises a plurality of die boards, wherein the assemblies are assemblies including at least one interface member as described above, and wherein:
each die board comprises a plurality of through holes, wherein the interface members of at least some of the assemblies are arranged in at least some of the through holes,
or
wherein the interface members of at least some of the assemblies are attached to an inner surface of at least one of the die boards, wherein the interface members are arranged to fit into recesses in the clamping device and/or into recesses in the die holding cylinder. This can serve to provide for a reliable clamping whereby the interface members may also help to correctly position to die boards in relation to the die holding cylinder. This kind of interface members can be compatible with die boards without specifically designed through holes, and help to ensuring alignment between the clamping devices and the openings in the interface members.

A yet further aspect of the disclosure relates to a method of preparing a die cutting machine, comprising the steps of:
providing a die holding cylinder with a plurality of recesses;
providing a plurality of die boards;
arranging the clamping device of an assembly as described above in each of at least some of the recesses;
and:
arranging an insert as described above in each of at least some through holes in at least one of the die boards; or
attaching at least one interface member as described above to an inner surface of at least one of the die boards.

### BRIEF DESCRIPTION OF THE DRAWINGS

To complete the description and in order to provide for a better understanding of the disclosure, a set of drawings is provided. Said drawings form an integral part of the description and illustrate embodiments of the disclosure, which should not be interpreted as restricting the scope of the disclosure, but just as examples of how the disclosure can be carried out. The drawings comprise the following figures:

FIG. 1 is a schematic exploded view of part of a die cutting machine (that is, a so-called die cutter) according to a first embodiment of the disclosure.

FIG. 2 is a perspective view of a clamping device of an assembly according to this embodiment of the disclosure.

FIG. 3 is a perspective exploded view of the clamping device.

FIGS. 4A-4D are a perspective top view, a perspective bottom view, a top view and a cross sectional side view of an interface member of the assembly according to this embodiment of the disclosure.

FIGS. 5A-5D are cross sectional side views of part of the die cutting machine according to this embodiment of the disclosure.

FIG. 6 is a cross sectional side view of part of the die cutting machine according to this embodiment of the disclosure.

FIG. 7 is a cross sectional side view of part of the die cutting machine of the same embodiment, but from a different angle.

FIGS. 8A-8C are a perspective exploded view and sectional side views, respectively, of part of the die cutting machine according to another embodiment of the disclosure.

FIGS. 9A-9C are a perspective exploded view and sectional side views, respectively, of part of the die cutting machine according to yet another embodiment of the disclosure.

### DETAILED DESCRIPTION OF THE DRAWINGS

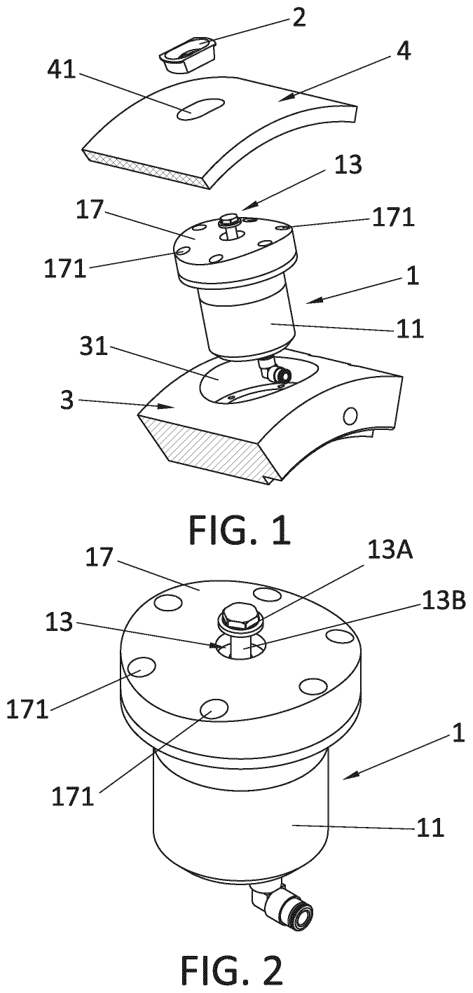

FIG. 1 schematically illustrates a portion of a die cutting machine comprising a die holding cylinder 3 and a plurality of die boards, a part of one die board 4 being shown in the figure. For example, the die holding cylinder 3 can support two or more die boards 4, each die board having a curved shape adapted to the external shape of the die holding cylinder 3, as known in the art. The die holding cylinder is typically a metallic cylinder, provided with a plurality of recesses 31 distributed over its surface. One of these recesses 31 is shown in FIG. 1. Each die board 4 typically comprises a plurality of through holes 41, one of which is shown in FIG. 1. Interface members in the form of a metallic inserts 2 are arranged in at least some of these through holes 41, the inserts comprising rims that rest on the upper surface of the respective die board 4.

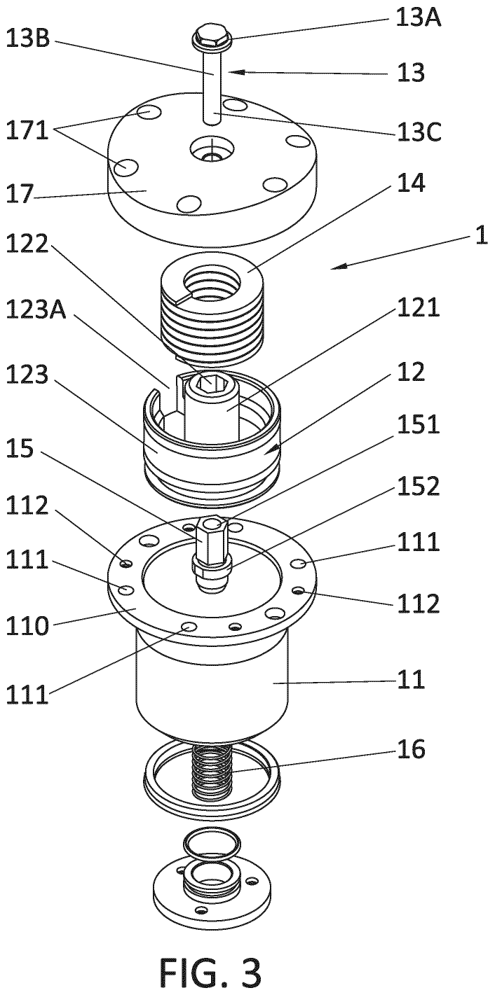

A clamping device 1 is arranged in each one of at least some of the recesses 31 in the die holding cylinder 3. The clamping device comprises a substantially disc-shaped cover 17 provided with a plurality of bores 171 distributed around its circumference, for receiving screws or bolts (not shown in FIG. 1; see FIG. 7 for one of these bolts 173) for attaching the clamping device 1 to the die holding cylinder 3, so that it will be securely retained in the respective recess 31. The clamping device 1, better shown in FIGS. 2 and 3, includes a fluid pressure cylinder 11, such as a pneumatic or hydraulic cylinder, with a piston 12 incorporating a nut 15 to which a clamping bolt 13 is attached by screwing. The fluid pressure cylinder 11 is configured to displace the piston 12 with the nut 15 axially outwards (radially outwards if the axis of the die holding cylinder is taken as the reference) when the fluid pressure cylinder is activated by the introduction of fluid in a chamber of the fluid pressure cylinder. The piston 12 (and, with it, the nut 15) is biased axially inwards by a clamping spring 14. The clamping bolt 13 comprises a shank 13B and a head 13A that extends radially outwards from the shank 13B. The bottom surface of part of the head is intended to contact the surface of the insert 2 so as to apply a clamping force onto the insert 2, for clamping the die board to the die holding cylinder 3. The clamping force is exerted by the clamping spring 14. As shown in FIG. 3, the nut 15 has externally a hexagonal cross section, and the nut is slidably arranged within a bore 122 in a central shaft portion 121 of the piston 12. The central shaft portion 121 is surrounded by the helicoidal clamping spring 14. The bore 122 has a hexagonal cross section that matches the external shape of the nut 15, so that the nut is blocked against rotation, whereas it is capable of sliding in the axial direction, as will be described more in detail below. The nut is biased axially outwards by a nut supporting spring 16 arranged within the piston 12.

The shank 13B of the clamping bolt 13 has a threaded end section 13C at the end opposite to the head 13A, that is, at the axially innermost end. This end section 13C is threadedly engaged with the threaded bore 151 of the nut 15. The head 13A of the clamping bolt has an upper portion that externally has a hexagonal cross section, thus facilitating the application of torque using a wrench or other suitable tool. In the case of jamming of the mechanism, for example, in the clamped state thereof, the bolt 13 can be removed by unscrewing it from the nut 15. This operation is facilitated by the fact that the head has a shape that facilitates the application of torque using a wrench, while the nut 15 is blocked against rotation in relation to the piston 12 as described above. Additionally, as shown in FIG. 3, the external wall 123 of the piston 12 that extends angularly around the piston includes a vertically extending slot 123A. In the mounted state, this slot receives a projection 172 (see FIG. 7) of the cover 17. Thus, also the piston is blocked against rotation around its axis.

The fluid pressure cylinder 11 is provided with a circumferential flange 110 at its upper end, the flange 110 being provided with a first set of bores 111 for receiving the screws or bolts 173 inserted via the bores 171 in the cover (one of these bolts is shown in FIG. 7), and a second set of bores 112 for receiving screws or bolts 174 for attaching the fluid pressure cylinder 11 to the cover 17 (one of these screws or bolts 174 is shown in FIG. 7).

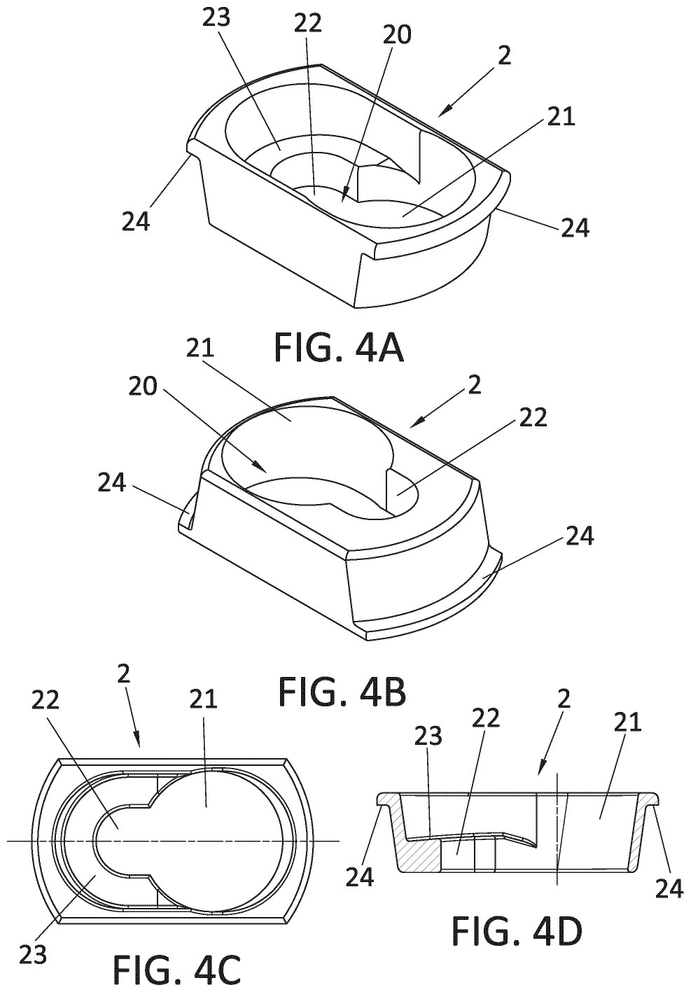

FIGS. 4A-4D schematically illustrate an insert 2 forming part of an assembly according to an embodiment of the disclosure. The insert can be of any suitable material, for example, of metal. The insert as shown in FIG. 4A is open at its top end. The bottom end is partially closed by a bottom featuring an opening 20 comprising a wider portion 21 and a narrower portion 22. The wider portion is dimensioned and shaped so as to allow the head 13A of the clamping bolt 13 to pass through it, whereas the narrower portion is shaped and dimensioned so as not to allow the head 13A of the clamping bolt to pass through it, but it is wide enough to house the shank 13B of the clamping bolt. Thus, in operation, the clamping bolt can be moved axially outwards, by displacement of the piston 12 caused by actuation of the fluid pressure cylinder 11, so that the head enters into the insert 2 via the wider portion 21 of the opening 20, whereafter the insert 2 is laterally or angularly shifted (for example, in the circumferential direction of the die holding cylinder) so that the shank 13B enters into the narrower portion 22 of the opening, whereafter the fluid pressure cylinder can be operated to let fluid out of the chamber to allow the piston 12 to descend axially inwards, pushed by the clamping spring 14, until the head 13A of the clamping bolt 13 abuts against the inner surface 23 of the insert surrounding part of the narrower portion 22 of the opening 20. Thus, the clamping bolt 13 transmits the clamping force exerted by the clamping spring 14 onto the insert 2. The clamping forces applied in this way by several clamping bolts pertaining to different assemblies thus serve to securely clamp the die board 4 provided with the inserts 2 to the die holding cylinder 3.

As shown, the insert 2 is partially wedge-shaped so that it narrows towards its bottom end. It is also provided with laterally extending rim or flange portions 24 around part of its circumference, to allow for reliable retention when placed in the corresponding through hole in a die board.

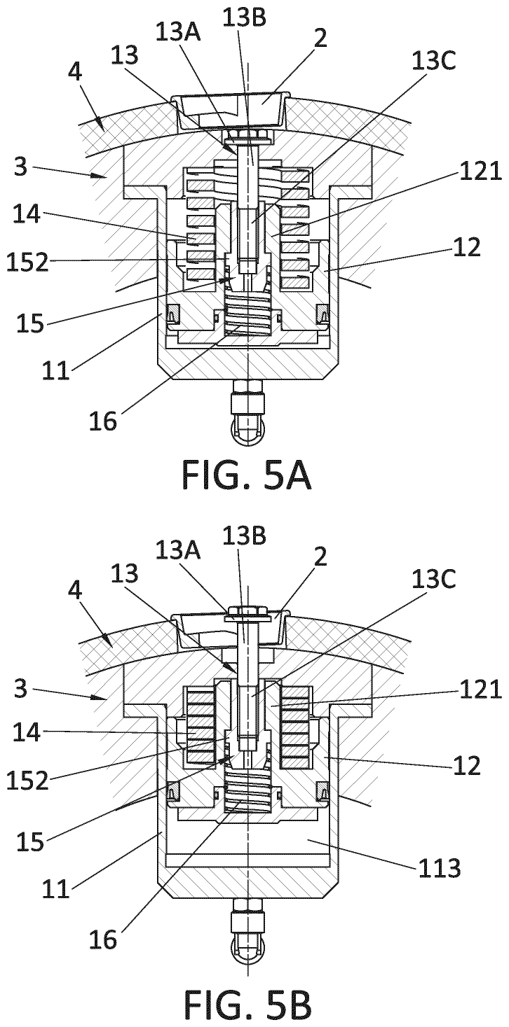

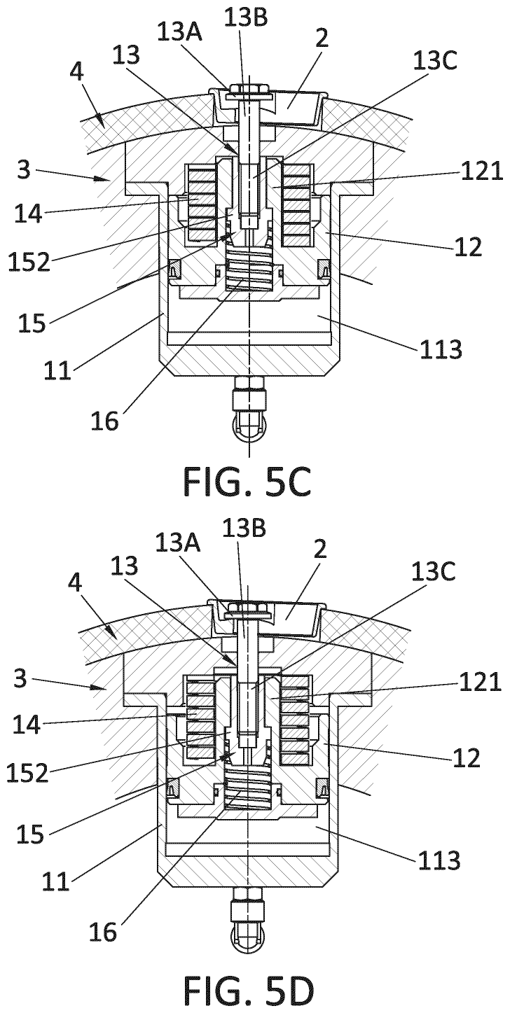

FIGS. 5A-5D schematically illustrate some of the above described components at different moments of the operation of the clamping mechanism of a rotary die cutter according to an embodiment of the disclosure.

FIG. 5A illustrates the clamping device with the piston 12 in an axially retracted position and the helicoidal clamping spring 14 in its maximally expanded state. The clamping bolt 13 is attached to the nut 15 which is retained within the piston by a circumferentially projecting rim or bulge 152 which abuts against the upper part of the inner surface of the piston, adjacent to the lower end of the hexagonal bore 122. The nut 15 is biased upwards (that is, axially outwards) by the nut supporting spring 16, likewise housed within the piston 12. A die board 4 has been applied onto the cylinder, and an insert 2 placed in a through hole in the die board is placed with the wider portion 21 of the opening 20 in the insert positioned axially above the head 13A of the clamping bolt.

In FIG. 5B the fluid pressure cylinder has been activated by injection of a fluid into the chamber 113 in part delimited by the lower surface of the piston, so that the piston has been displaced axially outwards (upwards in FIG. 5B), compressing the clamping spring 14 and pushing the head 13A of the clamping bolt through the wider portion 21 of the opening in the insert 2.

In FIG. 5C the die board 4 and the insert 2 have been shifted in relation to the clamping bolt so that the shank 13B of the clamping bolt has entered into the narrower portion 22 of the opening.

In FIG. 5D fluid has been allowed to flow out of the chamber 113 so as to reduce the pressure within the chamber, allowing the piston 12 to move axially inwards (downwards in FIG. 5D), under the pressure exerted by the expanding clamping spring 14. FIG. 5D shows the arrangement at the end of this movement, namely, with the head 13A of the clamping bolt abutting against the inner surface 23 of the insert 2, and the circumferential bulge 152 of the nut abutting against the internal top surface of the piston 12 adjacent to the bore 122, thereby preventing further expansion of the clamping spring. The pressure exerted by the clamping spring 14 at this stage thus represents the clamping force exerted by the head 13A of the clamping bolt onto the insert 2. Due to the use of the inserts 2, substantial clamping forces, such as clamping forces of more than 2000 N, such as more than 2500 N, can be applied without any substantial risk of damage to the die board.

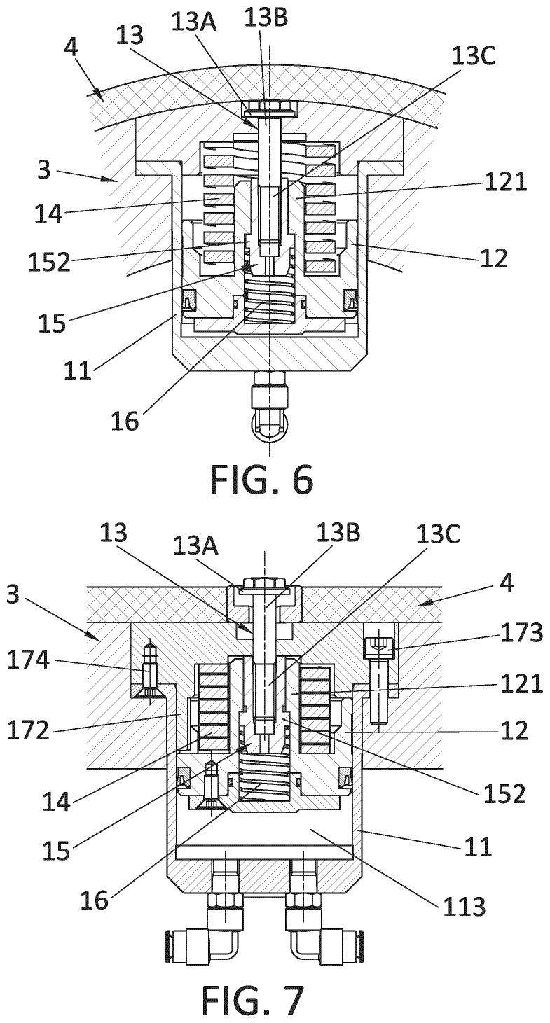

Often, when applying die boards onto a die holding cylinder, it is difficult or impossible to provide axial alignment between all of the clamping bolts and a corresponding insert. This means that if all the fluid pressure cylinders are activated for axial displacement outwards of the pistons, some of the clamping bolts will not be able to exit through a corresponding through hole in the die board. FIG. 6 illustrates an example of a clamping device according to an embodiment of the disclosure in which the head 13A of the clamping bolt is not facing an opening in the die board 4. When the fluid pressure cylinder 11 is activated and the piston 12 is pushed upwards, the head 13A of the clamping bolt will abut against the inner surface of the die board 4. When the piston continues to move upwards, the nut supporting spring 16 will be compressed. In this way, it is possible to avoid that the clamping bolt causes damage to or displacement of the die board 4.

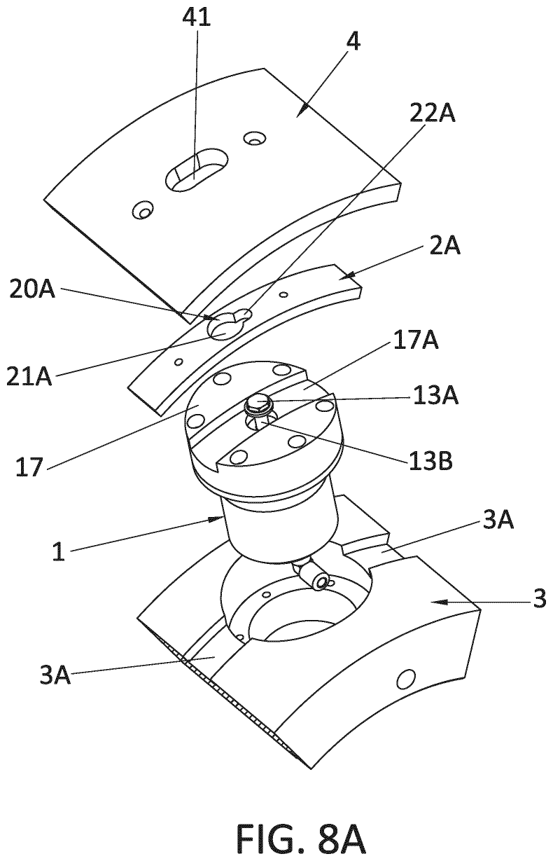

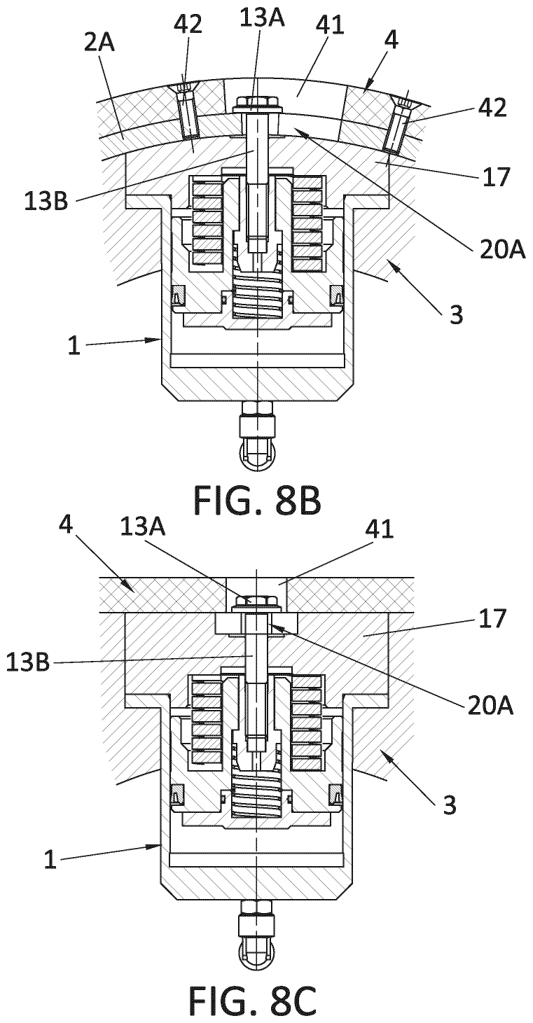

FIGS. 8A-8C illustrate another embodiment of the disclosure in which, instead of using an insert 2 as described above, the interface member 2A is a rib-like member with arcuate shape, which can be attached to the corresponding die board 4 by any suitable means, for example, by screws 42, as schematically illustrated in FIG. 8B. The arcuate shape of the interface member 2A corresponds to the arcuate shape of the radially external part of the die holding cylinder 3. The cover 17 of the clamping device 1 is provided with a recess 17A and the die holding cylinder 3 is likewise provided with recesses 3A. These recesses 17A and 3A form a continuous recess 3A+17A+3A extending in the circumferential direction of the die holding cylinder and arranged to receive the interface member 20A, thereby ensuring that the opening 20A thereof will be correctly positioned in relation to the head 13A of the clamping bolt in the axial direction of the die holding cylinder 3. By shifting the die board 4 in the circumferential direction of the die holding cylinder, the shank 13B of the clamping bolt 13 can be shifted from the wider portion 21A to the narrower portion 22A of the opening 20A in the interface member 2A, and vice-versa. What has been explained in relation to the insert 2 applies also to the arcuate interface member 2A, mutatis mutandis. The head 13A of the clamping bolt can be accessed from above (that is, from radially outside the die board 4) via the opening 41 in the die board 3. One advantage of this embodiment is that the interface member 2A does not have to be adapted to the opening 41 in the die board, as it does not fit into that opening: the interface member 2A is simply attached to the radially inner surface of the die board, for example, with screws.

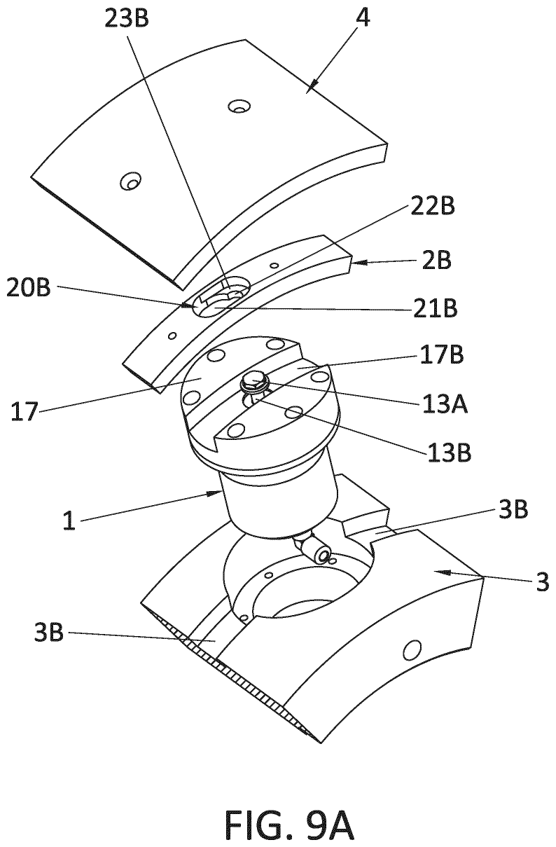

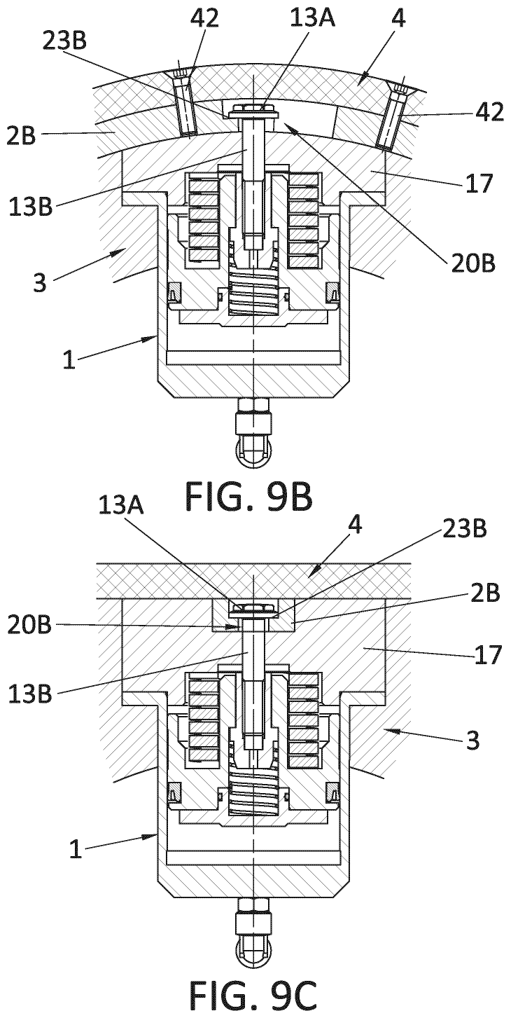

FIGS. 9A-9C illustrate an embodiment somewhat similar to the one of FIGS. 8A-8C, but which does not feature the opening 41 in the die board of the embodiment of FIGS. 8A-8C. On the other hand, the opening 20B intended to receive the clamping bolt 13 has, in the interface member 2B of the embodiment of FIGS. 9A-9C, a configuration that is different from the configuration of the corresponding opening 20A of the embodiment of FIGS. 8A-8C: whereas the opening 20A of the embodiment of FIGS. 8A-8C has the same cross section all throughout its radial extension (taking the die holding cylinder 3 as the reference), that is, whereas the opening 20A has the same shape at its radially outer or “upper” end as at its radially inner or “lower” end, the opening 20B of the embodiment of FIGS. 9A-9C has a different shape at its radially outer end than at its radially inner end. More specifically, the wider portion 21B and the narrower portion 22B of the opening are formed in a bottom 23B of the opening 20B that is recessed from its radially outer end, thereby providing for a space that can accommodate the head 13A of the clamping bolt between said bottom 23A and the die board 4, as best shown in FIGS. 9A and 9B. To access the head 13A of the clamping bolt from above, it is first necessary to remove the die board 4. An advantage of this embodiment is that it does not require any opening in the die board above the clamping bolt 13.

In this text, the term “comprises” and its derivations (such as “comprising”, etc.) should not be understood in an excluding sense, that is, these terms should not be interpreted as excluding the possibility that what is described and defined may include further elements, steps, etc.

The disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

1. A clamping device for clamping a die board onto a die holding cylinder of a rotary die cutting machine, the clamping device comprising a fluid pressure cylinder with an axially displaceable piston, a clamping bolt being attached to the piston, the clamping bolt comprising a shank and a head extending radially from the shank,
wherein the fluid pressure cylinder is configured for displacing the piston axially outwards in response to injection of fluid into the fluid pressure cylinder,
the clamping device further comprising a clamping spring arranged to bias the piston axially inwards,
wherein the clamping bolt comprises a threaded portion by which the clamping bolt is attached to the piston by a threaded connection.

2. The clamping device according to claim 1, wherein the head of the clamping bolt is configured to facilitate the application of torque to the clamping bolt for releasing the clamping bolt from the piston by unscrewing.

3. The clamping device of claim 1, wherein a nut is provided in the piston, the threaded portion of the clamping bolt being engaged with an internal thread of the nut.

4. The clamping device of claim 3, wherein the nut is arranged within the piston in an axially displaceable manner, the nut being biased axially outwards by a nut supporting spring.

5. The clamping device of claim 3, wherein the nut is blocked against rotation, and wherein the nut has an external shape matching an internal shape of a portion of the piston, so that the nut can slide in the axial direction within the piston, but is blocked against rotation.

6. The clamping device of claim 1, wherein the piston is blocked against rotation in relation to the fluid pressure cylinder.

7. The clamping device of claim 1, wherein the head of the clamping bolt comprises a portion with a circumference having a non-circular cross section.

8. The clamping device of claim 1, wherein the head of the clamping bolt comprises a recessed portion adapted for insertion of a tool for unscrewing the clamping bolt.

9. An assembly comprising a clamping device according to claim 1, wherein the assembly further comprises an interface member configured to be coupled to a die board, the interface member comprising an opening having a wider portion shaped and dimensioned to allow the head of the clamping bolt to pass through the wider portion, and a narrower portion shaped and dimensioned so as not to allow the head of the clamping bolt to pass through the narrower portion, so as to allow the clamping bolt to apply a clamping force onto the interface member.

10. The assembly of claim 9, wherein the interface member is of metal.

11. The assembly of claim 9, wherein the interface member is an insert to be inserted into a through hole in a die board, the insert comprising a bottom with the opening.

12. The assembly of claim 11, wherein the insert comprises a laterally extending rim portion surrounding at least part of the upper end of the insert, the rim portion being configured for being supported on an upper surface of a die board when the insert is placed in a through hole in the die board.

13. The assembly of claim 9, wherein the interface member is configured to be attached to an inner surface of a die board, wherein the clamping device and/or the die holding cylinder optionally comprises a recess for receiving at least part of the interface member, and wherein the interface member optionally is arc-shaped.

14. A die cutting machine comprising a die holding-cylinder and a plurality of clamping devices and/or a plurality of assemblies according to claim 9, wherein the clamping devices are inserted in recesses in the die holding cylinder.

15. The die cutting machine according to claim 14, further comprising a plurality of die boards, wherein the die cutting machine comprises a plurality of assemblies, and wherein:
each die board comprises a plurality of through holes, wherein the interface members of at least some of the assemblies are arranged in at least some of the through holes, or
wherein the interface members of at least some of the assemblies are attached to an inner surface of at least one of the die boards, wherein the interface members are arranged to fit into recesses in the clamping device and/or into recesses in the die holding cylinder.

16. A method of preparing a die cutting machine, comprising the steps of:
providing a die holding cylinder with a plurality of recesses;
providing a plurality of die boards;
arranging the clamping device of an assembly according to claim 9 in each of at least some of the recesses;
and:
arranging an insert to be inserted into a through hole in a die board, the insert comprising a bottom with the opening, in each of at least some through holes in at least one of the die boards; or
attaching at least one interface member configured to be attached to an inner surface of a die board, wherein the clamping device and/or the die holding cylinder optionally comprises a recess for receiving at least part of the interface member, and wherein the interface member optionally is arc-shaped, to an inner surface of at least one of the die boards.
